(19) United States
(12) Patent Application Publication
(10) Pub. No.: US 2010/0324961 A1
(43) Pub. Date: Dec. 23, 2010

(54) METHOD AND SYSTEM OF PROVIDING SERVICE ASSISTANCE USING A HIERARCHICAL ORDER OF COMMUNICATION CHANNELS

(75) Inventors: Amit Singh, Irving, TX (US); Surya Rebbapragada, Irving, TX (US); Dinyar Kavouspour, Plano, TX (US); Fari Ebrahimi, Basking Ridge, NJ (US); Roopa Kotha, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/490,039

(22) Filed: Jun. 23, 2009

(51) Int. Cl. G06Q 10/00; G06F 15/16; G06Q 50/00

(52) U.S. Cl. 705/8; 709/206

(57) ABSTRACT

An approach provides service assistance using a hierarchical order of communication channels. Service requests are received from a user. A plurality of different modes of communication functionality can be made available for interactivity with the user. A hierarchical order of the modes can be established in relation to the respective degree of communication interactivity. The mode of least degree of communication interactivity in the hierarchical order can be selected for initial communication with the user in response to the request for service. After communicating with the user in accordance with the selected mode, communication with the user can be changed to a communication mode higher in the hierarchical order if the service request has not been resolved.

### BACKGROUND INFORMATION

Businesses are increasingly challenged to provide responsive customer support and service in a cost effective manner. Some companies offer customer service using various technologies to gain a competitive edge in their market. Traditionally, companies have relied on telephony to address the customers' needs. For instance, toll-free (e.g., 800/888) service was initially employed to interact with customer service requests. Voice communication affords the customer access to a live agent for resolution of any questions. The business entity, however, bears the burden of personnel costs as well as the costs of the voice calls. Often, there is an inability to respond to customer requests without delay during periods of spikes in demand for services. Moreover, many questions may be easily resolved without the need for the attention of a live agent. Given the emergence of other communication means, e.g., instant messaging, email, text messaging, etc., customers are provided with multiple options for contacting customer service agents. Unfortunately, such communication means have not provided a user experience that facilitates high interactivity and promotes expedient resolution of customers' issues.

Therefore, there is a need for an approach for flexibly and efficiently interacting with users to provide customer assistance.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing interactive customer service in which different modes of communications are available to a user in a hierarchical order, according to an exemplary embodiment;

FIG. 2 is a diagram of an interactive service assistance system, according to an exemplary embodiment;

FIG. 3 is a flowchart of a process for communicating using a hierarchy of communication modes, according to an exemplary embodiment;

FIG. 4 is a flowchart of an exemplary call process, according to an exemplary embodiment;

FIG. 5 is a diagram of a hierarchical structure for communication channels that can be employed to provide service assistance functions, according to various embodiments; and

FIGS. 6A and 6B are diagrams of user interfaces utilized in the processes of FIGS. 3 and 4 for engaging in virtual chat and live chat, respectively, according to various embodiments; and

FIG. 7 is a diagram of a computer system that can be used to implement various exemplary embodiments.

### DESCRIPTION OF THE PREFERRED EMBODIMENT

A preferred apparatus, method, and software for providing customer service interactive communication are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

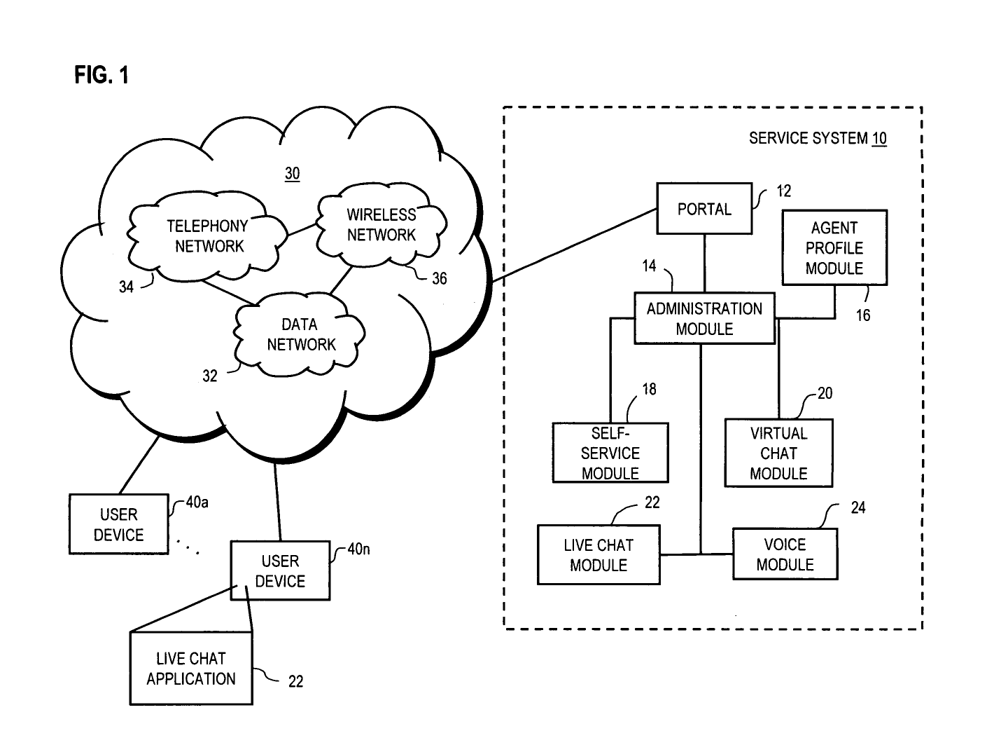

FIG. 1 is a diagram of a system capable of providing interactive customer service in which different modes of communications are available to a user in a hierarchical order, according to an exemplary embodiment. As illustrated in FIG. 1, service system 10 is coupled to a robust communication network 30 at communication portal 12. For the purposes of illustration, system 10 is described with respect to benefits administration for an enterprise or organization. Human resource departments within these organizations are charged with administering benefits using numerous means for disseminating information and address inquiries of employees. Typical enterprises have corporate internal helpdesks, and other personnel: e.g., various subject matter experts (SMEs), payroll support, vendor support, accounts payable, and agents to provide guidance for various technical and business approvals. This task of administering benefits is made more complex by the various communication channels available for contacting the users.

System 10 advantageously provides an integrated contact channel that bundles, for instance, self-service, virtual chat, live chat, email support, mobile chat, click-to-call, etc. to provide service according to the requirements of the users. As used herein, a customer is a user (or employee) of the organization that is authorized to access system 10. System 10, according to certain embodiments, implements a hierarchical (or tiered) approach to communicating with users, as to efficiently utilize system resources while efficiently addressing the customers' requirements. In other words, the tiered approach permits system 10 to structure the order or sequence in which different communication channels or means are provided to the customer.

With the advent of data communications technologies, approaches, such as online self-service, email support, virtual chat and live chat, have been introduced into commerce. Although the various approaches provide advantages with respect to traditional telephony (e.g., toll free or 800/888) service, each may be limited for handling particular customer needs. Online self-service is often difficult for the user to navigate. The user may need to frame a specific question or request that may or may not eventually lead to resolution. Live chat sessions provide cost benefits in comparison to voice interaction but still require live agent availability. Email support, which affords user contact with an agent, often incurs significant delays. Several interactive email reiterations may be required to obtain resolution. A customer who is seeking information for possible service may lose patience and a business opportunity may be lost. A virtual chat session, which has the appearance of current interaction with a live agent, may not adequately develop issues that lead to resolution.

Each service communication channel is more appropriate in different scenarios and involves different costs for implementation. The need exists for an integrated contact channel that provides service in accordance with customer needs. It would be desirable to provide the business with a tiered approach that segments customers based on the complexity of their questions but also decreases cost by offering the most cost-effective communication channels in priority.

The above described needs are fulfilled, at least in part, by system 10, which can receive a data communication that requests service from a user. A variety of different modes (that are to be available for interactivity with the user) of communication functionality can be configured. In one embodiment, a hierarchical order of the modes can be established in relation to the respective degree of communication interactivity. Implementation of each mode may involve different cost. The term “degree of communication interactivity” in this sense is taken to correspond to the depth of user interaction required with business personnel. The mode of least degree of communication interactivity in the hierarchical order can be selected for initial communication with the user in response to the request for service. After communicating with the user in accordance with the selected mode, communication with the user can be changed to a communication mode higher in the hierarchical order if the service request or inquiry has not been resolved. In other words, the user needs to continue communicating using other higher modes with greater degrees of interactivity.

In one embodiment, the system 10 contains a communication portal 12 configured to interface with communication network 30 that affords user access. An administration processing module (or platform) 14 is coupled between the communication portal 12 and a plurality of user contact channels, each providing different modes of functional communication interactivity. The administration processing platform 14 can determine a user need from input received at the communication portal 12 and activate the link between the communication portal 12 and a contact channel that is related to the user need. The multiple contact channels are thus bundled into an integrated interactive communication system.

In other words, administration module 14 interfaces with one or more contact channels to platforms (or modules) that provide different modes of interactive communication with user devices 40. These modules include self-service module 18, virtual chat module 20, live chat module 22 and voice module 24. The term “platform” or “module” as used herein is intended to encompass the processing and communication hardware and software appropriate to perform the function required. Such elements may be incorporated into a single location or distributed. Platform or module elements may in part be dedicated to a particular mode or shared to support multiple modes of operation.

According to certain embodiments, administration module 14 can set rules based on historical data of the customer's requests for service via portal 12 and offer a contact channel based on such rules. For example, self-service can be initially provided. Self-service module 18 may contain software that handles the way information, process rules and logic are collected, framed and accessed through decision support interactivity. The user can be presented with frequently asked questions (FAQs), customer built pages and navigation assistance. Moreover, administration module 14 may be provided with a search capability that would aid in navigation of the portal 12 and present FAQs related to the search. A computer generated application facilitates securing information for users through an automated interview fashion, such as a menu driven process in which links to stored information are provided.

The self-service platform 18 can be configured to provide assistance for a user 40 who may have, for example, customer support, technical support and employee support inquiries in an on-demand fashion. For example, an employee may use this tool to obtain information relating to employee benefits. Custom pages can be built based on the received input from the user to aid self-service, as well as to define rules for transferring communication to other user contact channels.

User input at the portal 12 can be monitored and form a basis for setting different support channels that can be offered to the user; this capability essentially provides the user with a “proactive invitation” to resolve the user's concerns. The user's satisfaction is thus enhanced by this offered proactive invitation, as well as by provision of static links that the customer may launch. That is, static links can also be made available to the customer to launch other support channels.

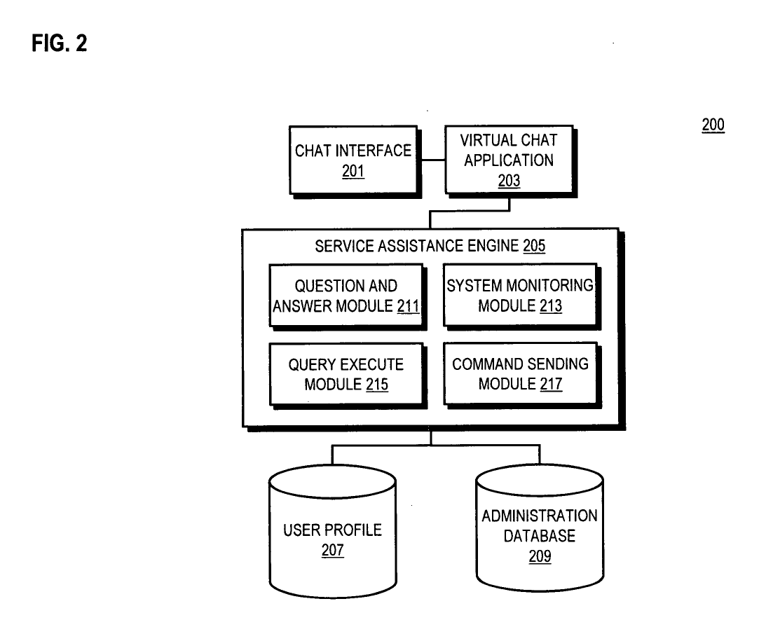

User profiles can be stored and maintained in data storage media (e.g., see FIG. 2, user profile database 207). The contact channels that are available may be dependent upon whether or not there is a user profile established for the user. In response to a request for service, the administration processing platform 14 can set available contact channels for use in accordance with an associated user profile. Profiles may be associated with business customers who can request information or help. Other profiles may be associated with employees who can access the system for assistance. A data page can be established in the user profile that contains information used for authorizing appropriate contact channels for the profile. For example, a customer's behavior on portal 12 is monitored and analyzed to determine a set of rules for selecting a contact channel. The administration processing platform 14 thus can prioritize the modes of communication interactivity in accordance with the user profile for a user initiated communication received at the communication portal 12.

In response to a received user initiated data communication, the administration processing platform 14 may couple the communication portal 12 to a user data self-service contact platform 18 (which, in this example, provides the least degree of communication interactivity). The self-service platform 18 may contain a plurality of user selectable links to information stored in the data storage media with navigation assistance. The administration module 14 can determine from interaction with the user whether or not the request for information or service has been resolved. If not, the user then can be coupled, instead, to a contact channel next in the hierarchical order. Such channel may include, for example, a virtual chat module 20 that can collect information from data received from the user in an automated virtual chat session and to generate data for output at the communication portal in response to the collected information. Virtual chat module 20 may, by way of example, contain “expert system” software that attempts to reproduce the performance of one or more human experts.

The functional mode of communication can be changed repeatedly in accordance with the hierarchical order if the service request still has not been resolved. For example, a live chat platform 22 can provide interactive data communication between the communication portal 12 and a live agent. At the highest hierarchical level, communication can be changed to voice interaction with a live agent by, for example scheduling a voice call. If agents are not available for either chat or call, email support can be provided to a customer. The tiered approach not only segments customers based on the complexity of their questions but also decreases cost to the business entity by offering the most cost-efficient channels in priority. Furthermore, agents can be cross trained across live chat and calls to better utilize them based on need. For example, agents would be moved to chat when the chat volume is higher than calls and vice versa. This sharing of agents across channels reduces costs while maintaining consistency and uniformity.

Live chat module 22 provides direct one-on-one data communication between user 40 and a live agent. Service system 10 typically employs a plurality of agents having particular expertise. Information identifying agents and background may be stored in agent profile module 16. In response to a user inquiry or request for service, an appropriate agent can be selected by administration module 14 by accessing agent profile module 16. A user contact channel can then be completed to the selected agent through the live chat platform to meet the user's specific requirements. Module 22, for example, may contain tools such as instant messengers, Internet Relay Chat, etc.

The system 10 has applicability to any entity, business or otherwise, that provides customer service type assistance. As an example, the business entity may be a communications provider that offers technical assistance or information about products to a subscriber or non-subscriber user 40. The term “customer” as contemplated herein is not limited to an individual who has purchased a company product. User 40 may be a technician employed by the business entity at remote service location who needs information. As another example, user 40 may be an employee who seeks human resources services. In such instance, the system may emulate a benefits administration system that contains information about employees. Agent profile module 16 thus may contain established profiles for users who have had previous contact with the entity. Profiles may not exist for other users but may be generated from interaction with such users.

The communication network 30 may comprise, for example, a data network 32, telephony network 34, and wireless networks 36. Data network 32 may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. Telephony network 34 may include a public switched telephone network (PSTN) or equivalent. Wireless network 36 may be, for example, a cellular network and may employ various technologies including, for example, code division multiple access (CDMA), enhanced data rates for global evolution (EDGE), general packet radio service (GPRS), global system for mobile communications (GSM), universal mobile telecommunications system (UMTS), etc., as well as any other suitable wireless medium, e.g., microwave access (WiMAX), Long Term Evolution (LTE) networks, wireless fidelity (WiFi), satellite, and the like. Communication network 30 may include session control capabilities such as those provided by the Internet protocol multimedia subsystem (IMS). The communication network 30 thus supports a variety of communications sessions including voice, video, text messaging, electronic mail (E-mail), instant messaging, etc. conducted with any user device 40 capable of communicating over the network 30.

FIG. 2 is a diagram of an interactive service assistance system, according to an exemplary embodiment. Interactive service assistance system 200 includes a chat interface 201, a virtual chat application 203, a service assistance engine 205, a flow definition database 207, and a query database 209. The chat interface 201 is used to conduct chat sessions with the users via administration portal 14 and portal 12. Chat sessions, as used herein, can also be referred to as instant messaging (IM) sessions or instant communication sessions. Upon contact by the user via the chat interface 201, the virtual chat application 203 initiates a virtual chat session that will be used to provide a variety of services of the organization, such as human resources type services. The virtual chat application 203 can gather information from the user (e.g., by posing questions to the user) that will be used by the service assistance engine 205. Virtual chat application 203 can communicate proposed solutions to the user, as formulated by the service assistance engine 205.

The service assistance engine 205 includes a question and answer module 211, a system monitoring module 213, a query execute module 215, and a command sending module 217. The service assistance engine 205 has access to a user profile database 207 and an administration database 209. The queries generated by the module 215 to the database 209 may be in the form of an XQuery, which is a structured query language (SQL). XQuery provides the capability to generate queries of eXtensible Mark-up Language (XML) data. Although the system query execute module 215 and database 209 are described with respect to XQuery, it is contemplated that other query languages can be utilized.

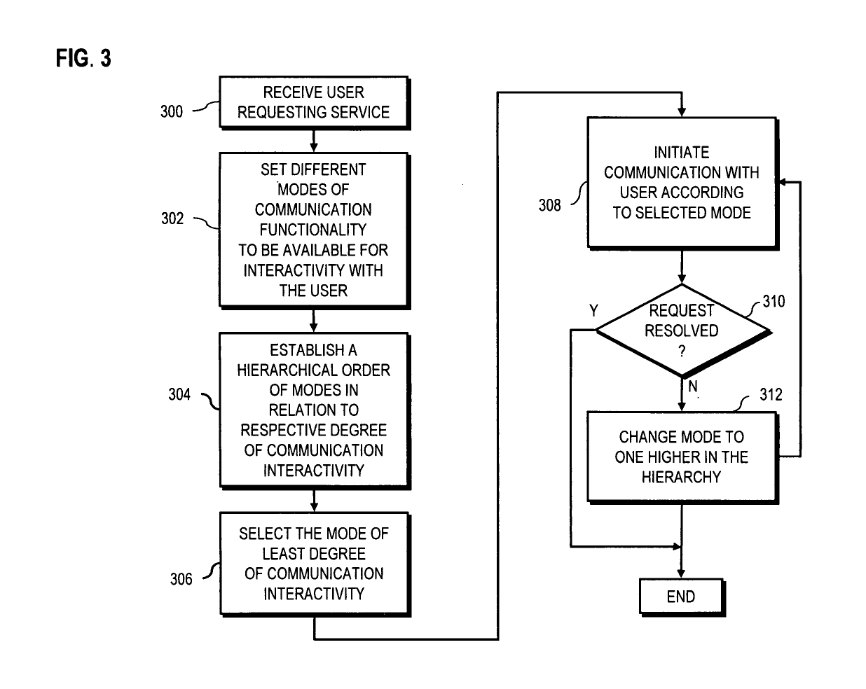

FIG. 3 is a flowchart of a process for communicating using a hierarchy of communication modes, according to an exemplary embodiment. As seen, in step 300, a user request for service is received. Next, different modes of communication functionalities can be set, whereby such capabilities are made available for interactivity with the user, per step 302. In step 304, the various modes of communication are arranged in a hierarchical order according to the respective degree of communication interactivity. In step 306, according to one embodiment, the mode of least degree of communication interactivity is selected. Subsequently, communication is initiated with the user according to the selected mode, as in step 308.

At this point, the process determines, as in step 310, with the request from the user has been resolved. If the request is not resolved (i.e., request is not otherwise satisfied), the process changes the mode of communication to the next, e.g., higher, mode in the hierarchical structure (step 312).

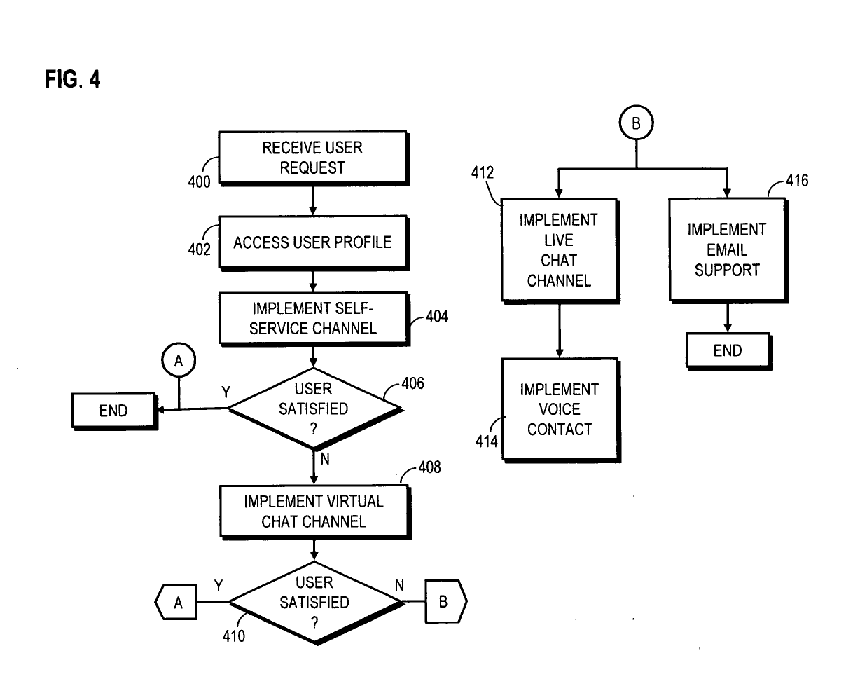

FIG. 4 is a flowchart of an exemplary call process, according to an exemplary embodiment. Under this scenario, the process is explained with respect to system 10 of FIG. 1. In step 400, the system 10 receives at portal 12 a communication request from user 40. Administration module 14, in step 402, accesses agent profile module 16 to determine whether a user profile exists for the incoming request. A profile can be a resource for determination of which user contacts can be made available by administration module 14. In one embodiment, user profile can also be used to enable or disable certain tiers or escalation support. Also, incoming requests into the contact channel can be prioritized using the user profile passed along with the contact initiation.

If user 40 is a subscriber, the profile may contain subscription information related to the subscribed offerings and the subscriber's personal information. If user 40 is an employee, the profile may contain specific information such as employee name, employee type, credentials, etc., which can be used for accurate routing and handling of the request. The information may be passed to others in the contact channel, using strict security measures.

Administration module 14 thus can develop a hierarchical order of available user contact channels in relation to respective degree of communication interactivity. Channels that involve higher overhead, for example, contact with live agents, may be limited to specific types of users. In the process illustrated in this flowchart, live agent contact channels may be made available, if at all, only after other alternative channels are exhausted. In step 404, self-service interactive communication is implemented. Customized page screens, based on an accessed user profile, can be presented to the user, who is coupled to the self-service platform. These screens may contain navigational aids with static links to stored information and FAQs. If no profile exists for the user and insufficient information is contained in the initial user request, a generalized page can be transmitted to the user.

Implementation of the self-service contact channel can continue until input from the user ceases. It is then determined, in step 406, whether the user has received the desired information. If the user is satisfied, the process ends. If not, the administration module will couple the user contact channel to the virtual chat channel in step 408 for implementation of interactive communication in a manner such as described above with respect to FIG. 2. The user is offered a more comprehensive and customized level of attention to resolve, interactively, the users needs. In an instance in which the user profile identifies a requirement for escalated support for a particular user, administration module 14 may determine thin step 408 is to be bypassed.

In step 410, administration module determines whether the user's need have been resolved. If the user is satisfied, the process terminates. If not, the process will continue if the user profile indicates that further interaction is to be authorized. If so authorized, administration module selects an appropriate agent to be contacted through live chat module 22 in step 412. The live agent may use the resources of virtual chat platform. If an agent is not available, an option to send an email for offline support can be transmitted, in step 416.

During live chat, agents can perform a co-browse session with the user. User specific information, stored with the user profile can be passed to the agent or further information can be requested of the system by the agent for comprehensive handling. When an agent has difficulty answering a user's question, the chat can be transferred to a supervisor or a supervisor can be invited for a conference. At the end of the interactive communication, information about the user and the conversation can be passed back to the administration module for documenting the conversation, or triggering a workflow for follow-up or additional actions. If the user's question has not been answered, an option to call back, such as a “click-to-call” icon can be presented to the user. If the user profile indicates the user as a high priority user, voice call communication with an agent can be authorized in step 414.

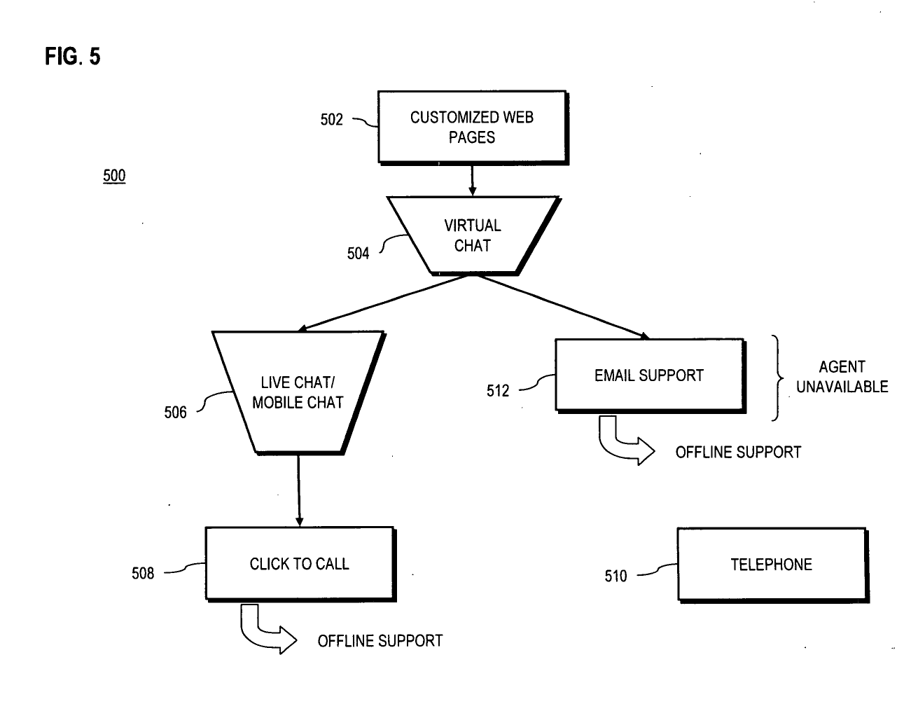

FIG. 5 is a diagram of a hierarchical structure for communication channels that can be employed to provide service assistance functions, according to various embodiments. According to certain embodiments, the customers' behavior (or usage) on portal 12 can be monitored continually, wherein a contact channel is offered based on certain preset rules according to the monitored behavior. In this example, a hierarchical arrangement 500 provides for first utilizing customized web pages 502 to address a user's inquiry. That is, system 10 can provide self-service channels, e.g., Frequently Asked Questions (FAQs), customer built pages, and/or navigation assistance. For an interactive session, system 10 can offer a virtual chat 504. If the described channels fail to answer the customers' questions or inquires, live chat (or mobile chat) 506 can be offered based on the agent's availability. Moreover, when live chat 504 fails to meet customers' expectations, a call can be scheduled (i.e., using a click-to-call mechanism 508 or a telephone 510 to place the call). When agents are not available for either chat or call, email support 512 can be provided to the customer. This tiered approach not only segments customers based on the complexity of their questions but also decreases cost of the companies by offering the most cost-effective channels in priority.

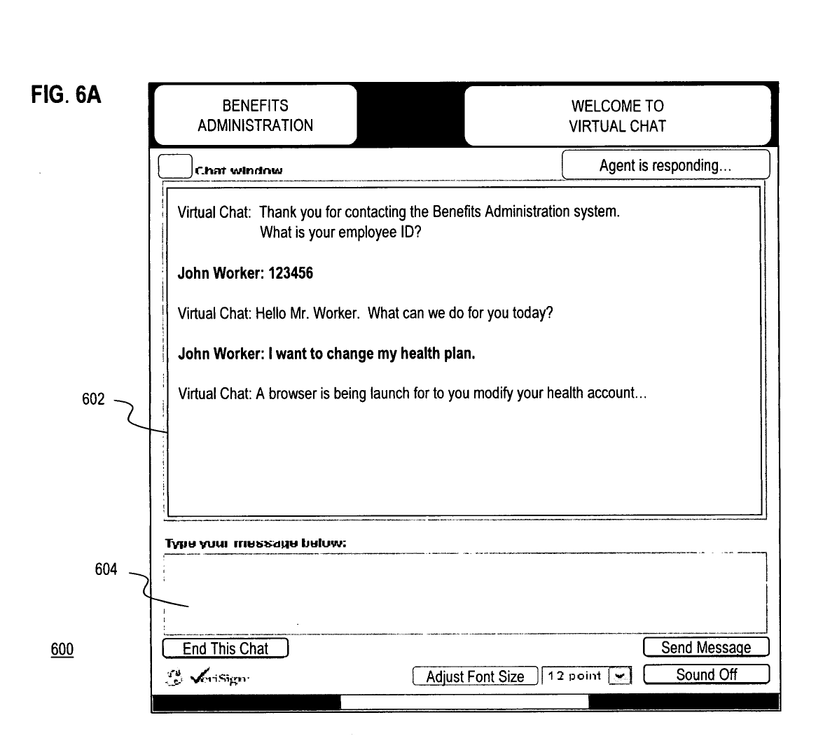

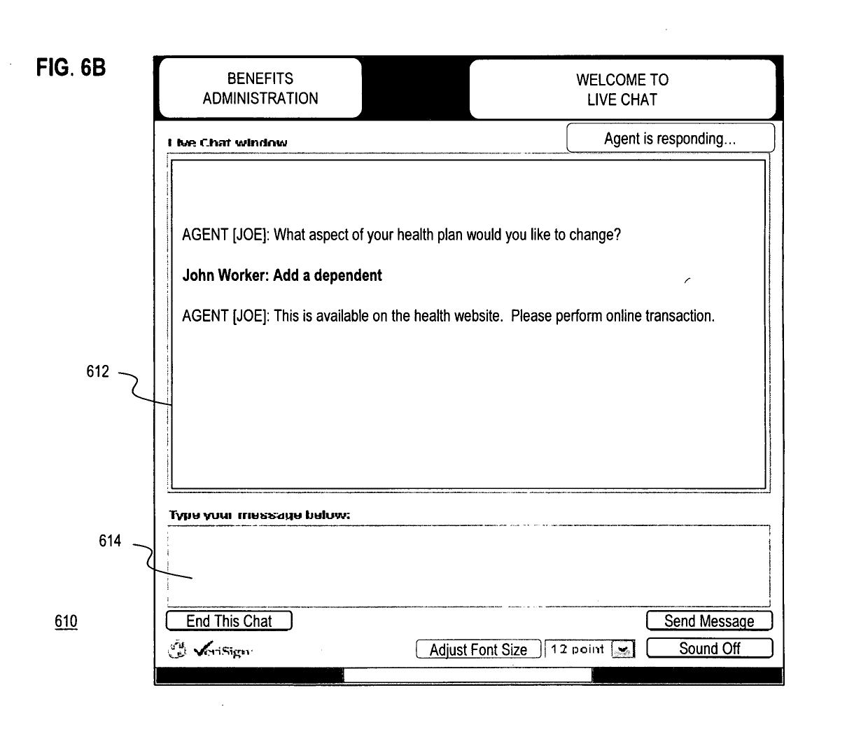

FIGS. 6A and 6B are diagrams of user interfaces utilized in the processes of FIGS. 3 and 4 for engaging in virtual chat and live chat, respectively, according to various embodiments. In this example, a graphical user interface (GUI) includes a screen 600, shown in FIG. 6A, for a virtual chat. As seen, a text box 602 facilitates information gathering from the user, e.g., “John Worker.” In this example, the chat with the user is automated; as mentioned the virtual chat can be driven by an expert system to prompt the user to collect information regarding the user's account and the services that the user is interested in. Box 604 permits the user to enter text in response to the questions.

In FIG. 6B, a screen 610 is provided to conduct a live chat with an actual human agent. Text box 612 provides for interaction between the user and an agent (denoted as “Agent [Joe]”). In this manner, the live agent can communicate with the user in a more natural form to service the needs of the user. Under this scenario, an employee, “Joe Worker,” seeks to modify an aspect of his health plan, namely to add a dependent. Thus, upon engaging the agent, a text prompt is provided asking what aspect of the health plan the employee seeks to modify. If the function of adding a dependent is available as an online transaction, the user can be directed accordingly.

The above arrangement, according to certain embodiments, advantageously provides a flexible and efficient method for interacting in support of customer assistance, and can reduce the cost of human resource.

One of ordinary skill in the art would recognize that the processes described above may be implemented via software, hardware (e.g., general processor, Digital Signal Processing (DSP) chip, an Application Specific Integrated Circuit (ASIC), Field Programmable Gate Arrays (Fogs), etc.), firmware, or a combination thereof. Such exemplary hardware for performing the described functions is detailed below.

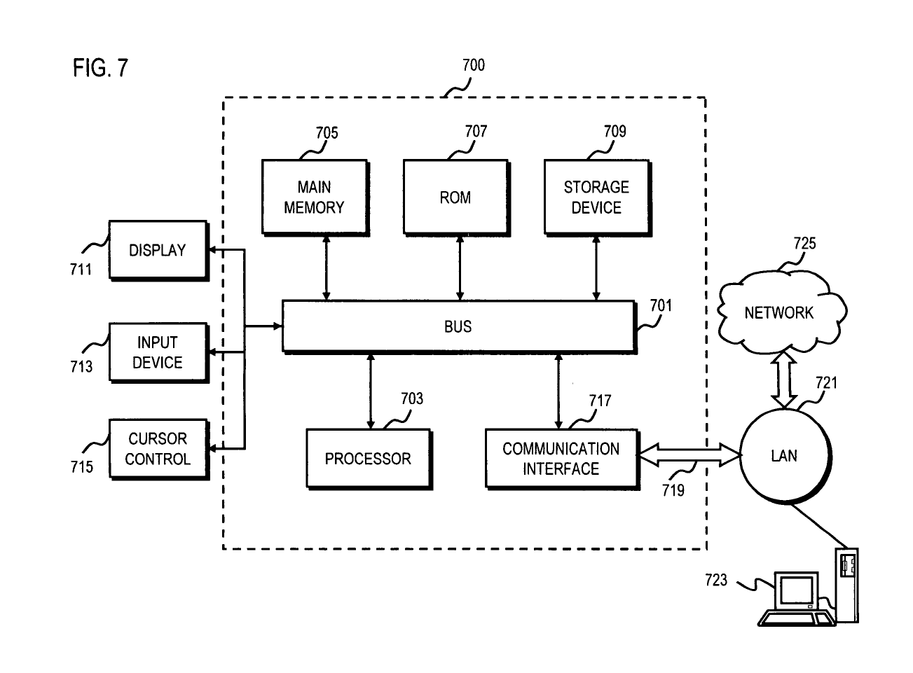

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a communication from a user requesting service;
setting a plurality of different modes of communication functionality that are to be available for interactivity with the user;
establishing a hierarchical order of the modes in relation to respective degree of communication interactivity;
selecting the mode of least degree of communication interactivity in the hierarchical order for initial communication with the user in response to the request for service;
communicating with the user in accordance with the selected mode; and
changing communication with the user to a communication mode higher in the hierarchical order if the service request has not been resolved.

2. A method as recited in claim 1, further comprising:
continuing to change the functional mode of communication in accordance with the hierarchical order if the service request has not been resolved.

3. A method as recited in claim 1, wherein the step of setting comprises accessing a profile corresponding to the user and determining which communication modes are associated with the user profile.

4. A method as recited in claim 1, wherein the step of communicating comprises:
generating a plurality of user selectable links to information stored in data storage media; and
outputting information data associated with a link selected by the user.

5. A method as recited in claim 4, wherein the step of generating comprises:
accessing a profile corresponding to the user; and
identifying a data page associated with the user profile.

6. A method as recited in claim 1, wherein the step of changing communication comprises:
conducting an automated virtual chat session with the user.

7. A method as recited in claim 6, wherein the step of conducting comprises:
accessing interactive flow definitions;
receiving data during an interactive data session with the user in accordance with the flow definitions;
collecting information from data received from a user; and
generating in response to the collected information for output to the user.

8. A method as recited in claim 7, further comprising:
changing the functional mode of communication to a live chat session with the user if the service request has not been resolved.

9. A method as recited in claim 1, wherein the step of changing communication comprises:
establishing email communication with the user.

10. An apparatus comprising:
a communication interface configured to receive a communication from a user requesting service; and
a processor configured to set a plurality of different modes of communication functionality that are to be available for interactivity with the user, and to establish a hierarchical order of the modes in relation to respective degree of communication interactivity,
wherein the processor is further configured to select the mode of least degree of communication interactivity in the hierarchical order for initial communication with the user in response to the request for service,
wherein communication is established with the user in accordance with the selected mode, the communication is changed with the user to a communication mode higher in the hierarchical order if the service request has not been resolved.

11. An apparatus as recited in claim 10, wherein the functional mode of communication is further change in accordance with the hierarchical order if the service request has not been resolved.

12. An apparatus as recited in claim 10, wherein a profile corresponding to the user is accessed to determine which communication modes are associated with the user profile.

13. An apparatus as recited in claim 10, wherein a plurality of user selectable links to information are generated and stored in data storage media, and information data associated with a link selected by the user is output.

14. An apparatus as recited in claim 13, wherein the processor is further configured to access a profile corresponding to the user, and to identify a data page associated with the user profile.

15. An apparatus as recited in claim 10, wherein the processor is further configured to conduct an automated virtual chat session with the user.

16. An apparatus as recited in claim 15, wherein the processor is further configured to access interactive flow definitions; to receive data during an interactive data session with the user in accordance with the flow definitions, to collect information from data received from a user, and generating in response to the collected information for output to the user.

17. An apparatus as recited in claim 16 the processor is further configured to change the functional mode of communication to a live chat session with the user if the service request has not been resolved.

18. An apparatus as recited in claim 10, wherein the processor is further configured to initiate establishment of email communication with the user.

19. A system comprising:
a communication portal configured to interface with a user;
an administration processing platform coupled to the communication portal; and
a plurality of user contact channels configured respectively to provide different modes of functional communication interactivity;
wherein the administration processing platform is configured to determine a user need from input received at the communication portal and to couple the communication portal to contact channel that is related to the user need.

20. A system as recited in claim 19, wherein the administration processing platform is configured to establish a hierarchical order of the user contact channels in relation to respective degree of communication interactivity.
